(19) United States
(12) Patent Application Publication
(10) Pub. No.: US 2013/0080487 A1
(43) Pub. Date: Mar. 28, 2013

(54) COMPUTING DEVICE AND METHOD FOR READING AND PROCESSING POINT-CLOUD DOCUMENT

(71) Applicants: CHIH-KUANG CHANG, Tu-Cheng (TW); XIN-YUAN WU, Shenzhen City (CN); WEI WANG, Shenzhen City (CN)

(72) Inventors: CHIH-KUANG CHANG, Tu-Cheng (TW); XIN-YUAN WU, Shenzhen City (CN); WEI WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/597,284

(22) Filed: Aug. 29, 2012

(30) Foreign Application Priority Data
Sep. 23, 2011 (CN) 201110286544.5

(51) Int. Cl. G06F 17/30

(52) U.S. Cl. 707/827; 707/E17.005

(57) ABSTRACT

A computing device determines N number of execution units that a CPU has and creates N number of threads, divides a point-cloud document into N number of blocks, and stores data in the N number of blocks into N number of arrays. The computing device determines X, Y, Z coordinate values of each point in each block of the point-cloud document according to separators among data in the block, and stores the X, Y, Z coordinate values of each point into corresponding arrays. The computing device combines all of the N number of arrays into one array, and generates a point-cloud according to the coordinate values of each point in the combined array.

### BACKGROUND

1. Technical Field

Embodiments of the present disclosure generally relate to data processing technology, and particularly to a computing device and a method for reading and processing a point-cloud document.

2. Description of Related Art

During the designing and manufacturing stage of three-dimensional products, error analysis is critical. Usually, the error analysis is done by a computer which compares a three-dimensional design drawing of a product with feature elements fitted and created using point-cloud data, obtained by scanning a physical object of the product. There may be a large quantity of point-cloud data, so reading the point-cloud data may be time-consuming.

### BRIEF DESCRIPTION OF THE DRAWINGS

FIG. 1 is a schematic diagram of one embodiment of a computing device including a reading and processing unit.

FIG. 2 is a block diagram of one embodiment of function modules of the reading and processing unit of the computing device in FIG. 1.

FIG. 3A-3B are flowcharts of one embodiment of a method for reading and processing a point-cloud document.

FIG. 4A-4B are schematic diagrams of embodiments of coordinate values in a block of the point-cloud document.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one”.

In general, the word “module”, as used herein, refers to logic embodied in hardware or firmware, or to a collection of software instructions, written in a programming language. One or more software instructions in the modules may be embedded in hardware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

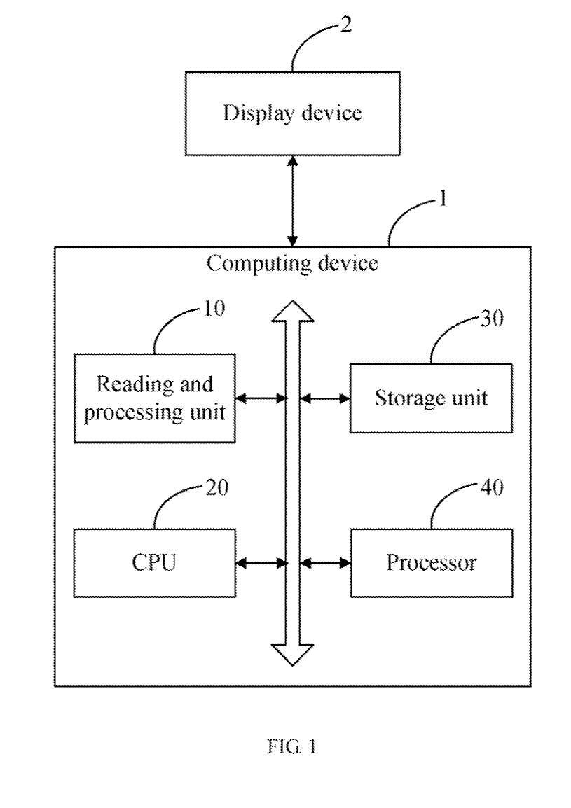

FIG. 1 is a schematic diagram of one embodiment of a computing device 1. In the embodiment, the computing device 1 includes a reading and processing unit 10, a central processing unit (CPU) 20, and a storage unit 30. The computing device 1 is electrically connected to a display device 2.

The display device 2 displays point-cloud documents and point-clouds generated according to data in the point-cloud documents. A point-cloud document includes coordinate data/information of each point of a point-cloud. Each row in the point-cloud document records X, Y, Z coordinate values of a point of the point-cloud.

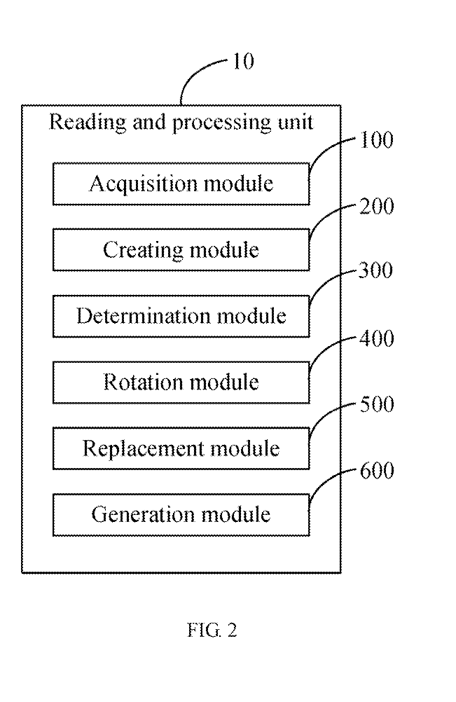

In one embodiment, the reading and processing unit 10 may include one or more function modules (as shown in FIG. 2). The one or more function modules may comprise computerized code in the form of one or more programs that are stored in the storage unit 30, and executed by the CPU 20 to provide the functions of the reading and processing unit 10. The storage unit 30 is a dedicated memory, such as an EPROM or a flash memory.

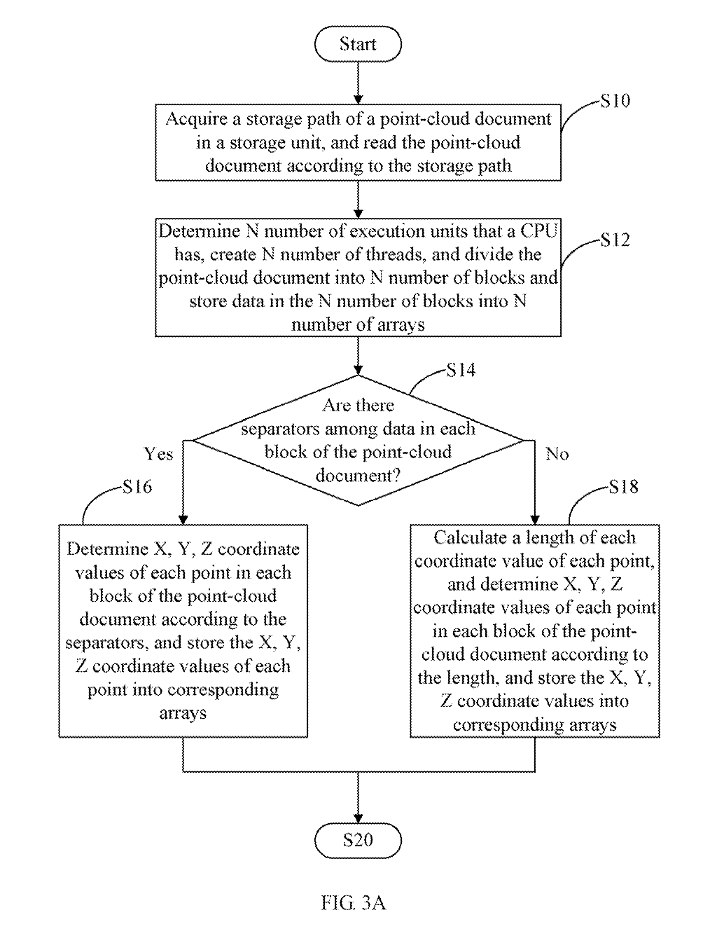

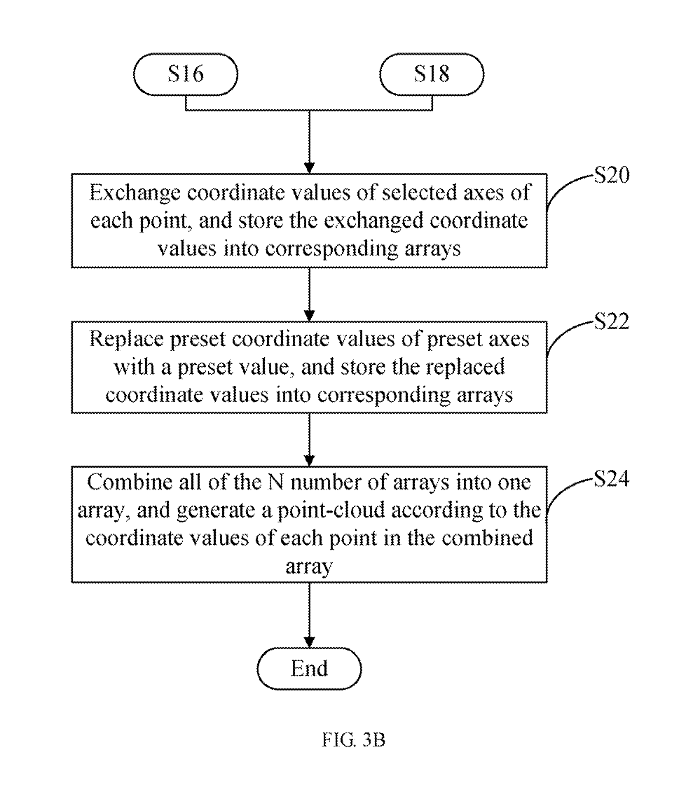

FIG. 2 is a block diagram of one embodiment of the function modules of the reading and processing unit 10. In one embodiment, the reading and processing unit 10 includes an acquisition module 100, a creating module 200, a determination module 300, a rotation module 400, a replacement module 500, and a generation module 600. A detailed description of functions of the modules 100-600 is given below in the description regarding FIG. 3A-3B.

FIG. 3A-3B are flowcharts of one embodiment of a method for reading and processing a point-cloud document. Depending on the embodiment, additional steps may be added, others removed, and the ordering of the steps may be changed.

In step S10, the acquisition module 100 acquires a storage path of a point-cloud document in the storage unit 30, and reads the point-cloud document according to the storage path.

In step S12, the creating module 200 determines how many execution units that the CPU 20 has (N number of execution units), creates N number of threads, and divides the point-cloud document into N number of blocks and stores data in the N number of blocks into N number of arrays. In computer engineering, an execution unit (also called a functional unit) is a part of the CPU 20 that performs operations and calculations called for by a Branch Unit, which receives data from the CPU 20. The N number of threads can process the point-cloud document at the same time, to shorten time of reading the data in the point-cloud document. Following steps S14-S22 are implemented by the N number of threads, where each thread processes a block of the point-cloud document.

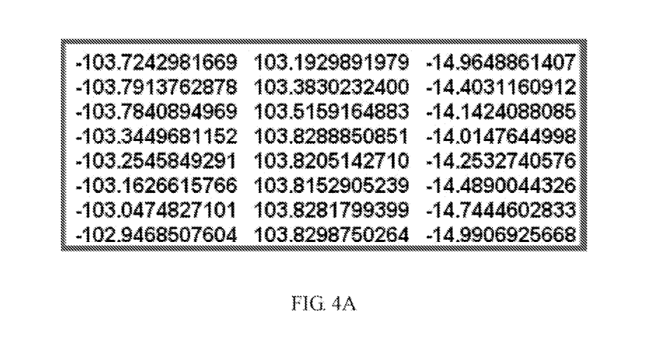

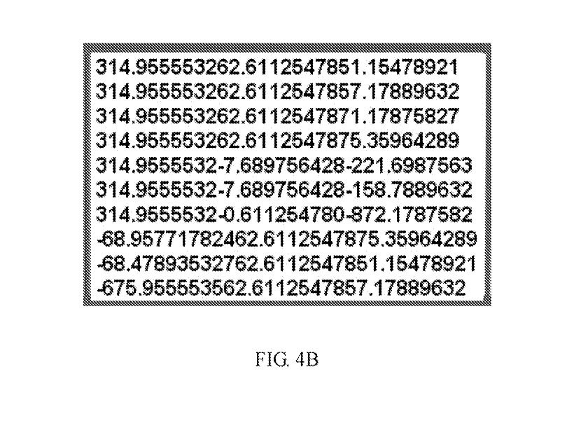

In step S14, the determination module 300 determines whether there are separators among data in each block of the point-cloud document. In the embodiment, the separator is any character excluding “−,” “+,” “.,” and numbers 0-9. For example, FIG. 4A shows data in a block that has separators (i.e., blank characters), and FIG. 4B shows data in a block that has no separators. If there are separators in each block of the point-cloud document, step S16 is implemented. If there are no separators in any block of the point-cloud document, step S18 is implemented.

In step S16, the determination module 300 determines X, Y, Z coordinate values of each point in each block of the point-cloud document according to the separators, and stores the X, Y, Z coordinate values of each point into corresponding arrays. In FIG. 4A, the determination module 300 determines X, Y, Z coordinate values of each point in the block of the point-cloud document according to the blank characters. For example, the determined coordinate values of the last row in FIG. 4A are X=−102.9468507604, Y=103.8298750264, Z=−14.9906925668.

In step S18, the determination module 300 calculates a length of each coordinate value of each point, and determines X, Y, Z coordinate values of each point in each block of the point-cloud document according to the length, and stores the X, Y, Z coordinate values into corresponding arrays.

Specifically, the determination module 300 selects a block of the point-cloud document, and reads a row of data in the block. The determination module 300 calculates a number of characters in the row (excluding the characters “−,” “+,” and “.”), and divides the number by three to obtain the length of each coordinate value of the point. The determination module 300 prompts a user, via the display device 2, to determine the length, and determines X, Y, Z coordinate values of each point in each block of the point-cloud document according to the determined length.

In FIG. 4B, the determination module 300 determines X, Y, Z coordinate values of each point in the block of the point-cloud document according to the determined length. For example, the number of characters in the last row in FIG. 4B is thirty (excluding the characters “−” and “.”), so the length of each coordinate value is ten. The determination module 300 prompts the user to confirm the determined length ten, and determines X, Y, Z coordinate values of the point according to the length ten. Then, the determined coordinate values of the last row are X=−675.9555535, Y=62.61125478, Z=57.17889632.

In step S20, the rotation module 400 exchanges coordinate values of selected axes of each point, and stores the exchanged coordinate values into corresponding arrays.

The rotation module 400 receives the selected axes which the user selects to exchange according to a direction of a three-dimensional design drawing that the point-cloud will be compared with, and acquires the coordinate values of the selected axes of each point from corresponding arrays. The rotation module 400 exchanges the coordinate values of the selected axes of each point, and stores the exchanged coordinate values into corresponding arrays. For example, the coordinate values of the point of the last row in FIG. 4A after exchanging X-axis and Y-axis are X=103.8298750264, Y=−102.9468507604, Z=−14.9906925668.

In step S22, the replacement module 500 replaces preset coordinate values of preset axes with a preset value, and stores the replaced coordinate values into corresponding arrays. Thus, noise is replaced with the preset value before fitting a feature element using a point-cloud generated according to the coordinate values of each point. For example, the replacement module 500 replaces the coordinate values of X-axis which are larger than 150.0000000000 with 150.0000000000.

In step S24, the generation module 600 combines all of the N number of arrays into one array, and generates a point-cloud according to the coordinate values of each point in the combined array.

Although certain inventive embodiments of the present disclosure have been specifically described, the present disclosure is not to be construed as being limited thereto.

Various changes or modifications may be made to the present disclosure without departing from the scope and spirit of the present disclosure.

What is claimed is:

1. A method being executed by a central processing unit (CPU) of a computing device, the method comprising:
(a) determining N number of execution units that the CPU has and creating N number of threads, dividing a point-cloud document into N number of blocks, and storing data in the N number of blocks into N number of arrays;
(b) determining X, Y, Z coordinate values of each point in each block of the point-cloud document according to separators among data in the block, and storing the X, Y, Z coordinate values of each point into corresponding arrays; and
(c) combining all of the N number of arrays into one array, and generating a point-cloud according to the coordinate values of each point in the combined array.

2. The method as claimed in claim 1, wherein step (b) further comprises:
(b2) calculating a length of each coordinate value of each point, and determining X, Y, Z coordinate values of each point in each block of the point-cloud document according to the length, and storing the X, Y, Z coordinate values into corresponding arrays, in response that there are no separators among data in each block of the point-cloud document.

3. The method as claimed in claim 1, wherein between step (b) and step (c), the method further comprises:
exchanging coordinate values of selected axes of each point, and storing the exchanged coordinate values into corresponding arrays; and
replacing preset coordinate values of preset axes with a preset value, and storing the replaced coordinate values into corresponding arrays.

4. The method as claimed in claim 1, wherein the separator is any character excluding the group consisting of “−,” “+,” “.,” and numbers 0-9.

5. The method as claimed in claim 2, wherein the step (b2) further comprises:
selecting a block of the point-cloud document, and reading a row of data in the block;
calculating a number of characters in the row, and dividing the number by three to obtain the length of each coordinate value of the point; and
prompting a user to determine the length, and determining X, Y, Z coordinate values of each point in each block of the point-cloud document according to the determined length.

6. A non-transitory storage medium storing a set of instructions, the set of instructions capable of being executed by a central processing unit (CPU) of a computing device, to perform a method comprising:
(a) determining N number of execution units that the CPU has and creating N number of threads, dividing a point-cloud document into N number of blocks, and storing data in the N number of blocks into N number of arrays;
(b) determining X, Y, Z coordinate values of each point in each block of the point-cloud document according to separators among data in the block, and storing the X, Y, Z coordinate values of each point into corresponding arrays; and
(c) combining all of the N number of arrays into one array, and generating a point-cloud according to the coordinate values of each point in the combined array.

7. The non-transitory storage medium as claimed in claim 6, wherein step (b) further comprises:
(b2) calculating a length of each coordinate value of each point, and determining X, Y, Z coordinate values of each point in each block of the point-cloud document according to the length, and storing the X, Y, Z coordinate values into corresponding arrays, in response that there are no separators among data in each block of the point-cloud document.

8. The non-transitory storage medium as claimed in claim 6, wherein between step (b) and step (c), the method further comprises:
exchanging coordinate values of selected axes of each point, and storing the exchanged coordinate values into corresponding arrays; and
replacing preset coordinate values of preset axes with a preset value, and storing the replaced coordinate values into corresponding arrays.

9. The non-transitory storage medium as claimed in claim 6, wherein the separator is any character excluding the group consisting of “−,” “+,” “.,” and numbers 0-9.

10. The non-transitory storage medium as claimed in claim 7, wherein the step (b2) further comprises:
selecting a block of the point-cloud document, and reading a row of data in the block;
calculating a number of characters in the row, and dividing the number by three to obtain the length of each coordinate value of the point; and
prompting a user to determine the length, and determining X, Y, Z coordinate values of each point in each block of the point-cloud document according to the determined length.

11. A computing device, the computing device comprising:
a central processing unit (CPU);
a storage unit;
one or more programs that are stored in the storage unit and are executed by the CPU, the one or more programs comprising:
a creating module that determines N number of execution units that the CPU has and creates N number N of threads, divides a point-cloud document into N number of blocks, and stores data in the N number of blocks into N number of arrays;
a determination module that determines X, Y, Z coordinate values of each point in each block of the point-cloud document according to separators among data in the block, and stores the X, Y, Z coordinate values of each point into corresponding arrays; and
a drawing module that combines all of the N number of arrays into one array, and generates a point-cloud according to the coordinate values of each point in the combined array.

12. The computing device as claimed in claim 11, wherein the determination module further calculates a length of each coordinate value of each point, and determines X, Y, Z coordinate values of each point in each block of the point-cloud document according to the length, and stores the X, Y, Z coordinate values into corresponding arrays, in response that there are no separators among data in each block of the point-cloud document.

13. The computing device as claimed in claim 11, wherein the one or more programs further comprises:
a rotation module that exchanges coordinate values of selected axes of each point, and stores the exchanged coordinate values into corresponding arrays; and
a replacement module that replaces preset coordinate values of preset axes with a preset value, and stores the replaced coordinate values into corresponding arrays.

14. The computing device as claimed in claim 11, wherein the separator is any character excluding the group consisting of “−,” “+,” “.,” and numbers 0-9.

15. The computing device as claimed in claim 12, wherein the determination module further:
selects a block of the point-cloud document, and reads a row of data in the block;
calculates a number of characters in the row, and divides the number by three to obtain the length of each coordinate value of the point; and
prompts a user to determine the length, and determines X, Y, Z coordinate values of each point in each block of the point-cloud document according to the determined length.
